(19) United States
(12) Patent Application Publication
(10) Pub. No.: US 2012/0036242 A1
(43) Pub. Date: Feb. 9, 2012

(54) METHOD AND SENSOR NETWORK FOR ATTRIBUTE SELECTION FOR AN EVENT RECOGNITION

(75) Inventors: Georg Wittenburg, Berlin (DE); Norman Dziengel, Berlin (DE); Christian Wartenburger, Berlin (DE)

(73) Assignee: FREIE UNIVERSITAET BERLIN, Berlin (DE)

(21) Appl. No.: 13/146,623

(22) PCT Filed: Jan. 27, 2010
(86) PCT No.: PCT/EP2010/050920

§ 371 Date: Oct. 14, 2011

(30) Foreign Application Priority Data
Jan. 27, 2009 (DE) 10 2009 006 560.1

(51) Int. Cl. G06F 15/177

(52) U.S. Cl. 709/222

(57) ABSTRACT

A method for attribute selection for an event recognition in sensor networks is provided. The method comprising the following steps: in a configuration phase providing a quantity of attributes by sensor nodes of a sensor network, which characterize an event to be recognized, together with information on the topological origin of the attributes within the sensor network, and selecting a sub-quantity from the quantity of attributes, wherein the selection is made in consideration of the information on the topological origin of the attributes, and in an execution phase performing an event recognition for an event to be currently recognized on the basis of attributes which belong to a selected sub-quantity.

### CROSS-REFERENCE TO A RELATED APPLICATION

This application is a National Phase Patent Application of International Patent Application Number PCT/EP2010/050920, filed on Jan. 27, 2010, which claims priority of German Patent Application Number 10 2009 006 560.1, filed on Jan. 27, 2009.

### BACKGROUND

This invention relates to a method and a sensor network for attribute selection for an event recognition.

Since about 10 years, wireless sensor networks (WSNs) are the object of academic research. They consist of a plurality of sensor nodes which each include at least one sensor, a processor, a data memory (with little storage space as compared to commercially available PCs), a radio module and an energy supply, for example in the form of a battery. The individual sensor nodes pick up measurement data from the environment and exchange them same by radio among each other or with a base station. Potential applications of sensor networks can be found in the field of measurement and surveillance technology, such as in the exploration of regions difficult to access or in the surveillance of buildings and plants.

Previous applications of wireless sensor networks mostly are based on a simple data transmission of measurement values to a base station for evaluation. This has the disadvantage that due to the energy expenditure for a potentially great number of transmissions the useful life of the sensor network is shortened. Recent approaches therefore try to analyze the data directly after the data acquisition on one or more sensor nodes, in order to draw conclusions about a detected event. The scope of the data transmission between the sensor nodes and/or to a base station thereby is reduced. This in turn leads to a reduced energy consumption and hence to a longer useful life of the sensor network.

In Dennis Pfisterer: “Comprehensive Development Support for Wireless Sensor Networks”, inaugural dissertation, University of Lübeck, Faculty of Technology and Science, Lübeck, October 2007, an address assignment and group formation in sensor networks is described, in which addresses are assigned in dependence on the spreading place of a sensor node, sensor nodes transmit their absolute position together with the measurement data, and groups of sensor nodes are formed, in order to support for example a hierarchical routing. These are technical fundamentals for current sensor networks.

The document DE 10 2007 026 528 A1 describes a method for collecting surveillance data of communication devices. There is observed a heterogeneous sensor network, i.e. a sensor network which comprises several different types of sensors on the individual sensor nodes. An optimization in the key distribution is provided for the safe communication between the sensor nodes and the base station, which is based on a grouping of the sensor nodes by location and type of the sensor.

The definition of an event varies depending on the field of application of the sensor network and ranges from a volcano eruption to the recognition of vehicles, cf. for example Werner-Allen, G. et al.: “Fidelity and Yield in a Volcano Monitoring Sensor Network”, Proceedings of the Seventh USENIX Symposium on Operating Systems Design and Implementation, Seattle, USA, November 2006. For recognizing such events, heuristics such as threshold measurements or the verification of the number of sensor nodes concerned commonly are used, due to which, however, especially with more complex events an only limited recognition accuracy can be achieved.

In Dziengel, N.: “Verteilte Ereigniserkennung in Sensornetzen”, thesis, Free University of Berlin, October 2007, and Dziengel, N. et al.: “Towards Distributed Event Detection in Wireless Sensor Networks”, Adjunct Proceedings of the 4th IEEE/ACM International Conference on Distributed Computing in Sensor Systems (DCOSS '08), Santorini Island, Greece, June 2008, an approach for event recognition is described, in which methods from the pattern recognition are developed further for application in a sensor network. The approach adopted provides a pattern recognition on the basis of distributed information, which is provided by the individual sensor nodes of a sensor network. The aim of the pattern recognition is the same as the aim of every pattern recognition, namely to assign an input of raw data to a more abstract class in the output. In the distributed event recognition attribute vectors and/or classification results therefore are exchanged between the sensor nodes involved in the process.

What is decisive for the accuracy of a classification and hence for the recognition rate is the selection of the attributes to be extracted from the raw data. The trivial solution to use all available attributes has the disadvantage that data must be exchanged and processed in the classification phase unnecessarily. This leads to a shorter useful life of the sensor network. Therefore, it is desirable to reduce or filter the attributes used for the classification.

### SUMMARY

An object of the invention is to provide a method and a sensor network for attribute selection, which perform a selection of the attributes to be provided for an event recognition in such a way that on the one hand a sufficiently accurate recognition is possible and on the other hand the communication effort between the individual sensor nodes remains practicable.

An exemplary embodiment of the invention provides an attribute selection which is made in consideration of topological information as regards the position of the individual sensor nodes in the sensor network. During the attribute selection information on the topological origin of the attributes within the sensor network is considered. The improved attribute selection provided thereby provides for a practicable compromise between recognition accuracy and communication effort between the sensor nodes.

In particular, an exemplary embodiment of the invention provides a method for attribute selection for an event recognition in sensor networks, which in a configuration phase includes the following steps:
providing a quantity of attributes by sensor nodes (1-6) of a sensor network, which characterize an event to be recognized, together with information on the topological origin of the attributes within the sensor network, and
selecting a sub-quantity from the quantity of attributes, wherein the selection is made in consideration of the information on the topological origin of the attributes.

In an execution phase, an event recognition occurs for an event to be currently recognized on the basis of merely such attributes which belong to a selected sub-quantity. In the configuration phase, such attribute quantity formation and attribute selection is made for a plurality of possible events to be recognized.

Furthermore, it is provided that from the attributes of the attribute sub-quantity selected for each event, a multi-dimensional reference attribute vector each is formed. In the execution phase, a determined multi-dimensional current attribute vector for event recognition is compared with these reference attribute vectors via a distance measure.

Attributes which characterize an event for example can be histogram values and/or minimum values and/or maximum values and/or mean values and/or slope values for defined time intervals and/or intensity changes for defined time intervals. Such classes or types of attributes also are referred to as attribute types.

In one exemplary configuration variant, selecting a sub-quantity comprises making a weighting to the effect that such attributes of the total quantity of the determined attributes are weighted more, in which corresponding attributes (i.e. attributes of the same attribute type) are also determined by other network nodes. Thus, the selection criterion is the multiple use of attributes of the same attribute type by the individual sensor nodes. An attribute reduction is effected by attribute type reduction. The remaining attributes in the quantity of selected attributes belong to on the whole less attribute types.

In a further exemplary configuration variant, selecting a sub-quantity comprises a weighting to the effect that such attributes of the total quantity of the determined attributes are weighted more which originate from a node which already has contributed attributes for selection. The selection thus is made in consideration of the question whether other attributes have already been selected by a certain sensor node. Such selection additionally provides for a reduction of the sensor nodes involved in an event recognition and hence of the necessary data transmission operations.

These two configuration variants can also jointly be utilized in the attribute selection.

In a further exemplary aspect it is provided that selecting a sub-quantity comprises carrying out an iterative selection process on the total quantity of the attributes determined. The attribute selection comprises a quantity search method which selects sub-quantities for finding a best possible quantity. For evaluating these sub-quantities, a measure for the quality assessment of attribute quantities is required. The quality of an attribute quantity is given by the ability of this quantity to exactly differentiate between several classes. The quality criterion hence is connected with the distance of the attribute vectors of the classes, wherein arbitrary distance measures can be used. The quality of an attribute quantity for example can be determined with reference to a cross-validation algorithm.

In one exemplary aspect of the invention, selecting a sub-quantity initially is effected by an iterative selection process on the total quantity of the attributes determined, such as a cross-validation, and the selected attributes then are additionally weighted as described above, namely a) with respect to such attributes which are also determined by other network nodes, and/or b) in consideration of the question whether other attributes have already been selected by a certain sensor node. The attribute selection thus consists of a selection method with which the total quantity of the attributes is reduced, and of an evaluation function for the attributes selected in this way, which further reduces the quantity of the selected attributes.

In one exemplary aspect of the invention, providing a quantity of attributes which characterize an event to be recognized is effected by means of the following steps during the configuration phase:
providing a plurality of sensor nodes of the sensor network,
executing an event to be recognized,
on each sensor node detecting measurement values which are triggered by the event to be recognized,
on each sensor node determining a plurality of attributes which characterize the event from the measurement values,
forming the quantity of attributes which characterize an event to be recognized from the sum of attributes determined on the sensor nodes.

In one exemplary aspect, the execution phase comprises the attributes:
providing the reference attribute vectors determined in the configuration phase,
providing information on an attribute selection made in the configuration phase,
for an event currently to be recognized determining merely attributes on all or some of the sensor nodes which belong to the attribute selection made,
representing these attributes as multi-dimensional current attribute vector, and
making a classification by comparing the current attribute vector with the reference attribute vectors.

In accordance with a further exemplary aspect of the invention, the information on the topological origin of the attributes is encoded in the network addresses of the sensor nodes, e.g. by relative coordinates or a continuous numbering of the sensor nodes. This aspect of the invention thus makes use of a topology encoded in the addressing of the nodes, in order to determine the relative position of the nodes among each other. Recorded attributes are combined with the information about this relative position. In the training phase, attributes of different types and of different relative positions thus spread out the largest possible attribute vector space on which the attribute selection occurs. The information on the relative position of the nodes is preserved in the attribute selection.

The coding is effected with respect to the propagation characteristic of the event to be recognized, i.e. it is adapted to the propagation characteristic of the event to be recognized. The neighborhood relation of the sensor nodes along a fence merely represents one exemplary embodiment, in which during an event the measured mechanical vibration of the fence propagates along the fence and in doing so is attenuated. In a further exemplary embodiment the position of the nodes in the plane of the address is encoded, e.g. by means of relative coordinates at the spreading place or by means of continuous numbers with known dimensions of the sensor network (with respect to the number of nodes in terms of length and width of the spread sensor network). With uniform spreading, the location-independent relative position of the nodes among each other in turn can be calculated from the addresses. Such coding is suitable for recognizing event patterns which in physical terms uniformly spread in the surface, e.g. the temperature of the waste heat of a source of fire. In a further exemplary embodiment, the position of the nodes in the space likewise can be encoded in the address, e.g. by means of relative coordinates or a continuous numbering, so that event patterns with a spatial propagation, e.g. the gas concentration around a gas leak in a large-scale industrial plant, can be recognized.

Furthermore, it is pointed out that a grouping of the sensor nodes according to a traditional clustering does not take place. Rather, the quantity of the sensor nodes which process an event is obtained dynamically in the course of the pattern recognition from the quantity of previously selected attributes and from the position of the sensor nodes relative to each other.

The invention furthermore relates to a sensor network with a plurality of sensor nodes, wherein the sensor network can be configured for carrying out a configuration phase and for carrying out an execution phase. In the configuration phase, the sensor network is configured to:
provide a quantity of attributes by the sensor nodes of the sensor network, which characterize an event to be recognized, together with information on the topological origin of the attributes within the sensor network, and
select a sub-quantity from the quantity of attributes, wherein the selection is made in consideration of the information on the topological origin of the attributes. In the execution phase the sensor network is configured to perform an event recognition for an event to be currently recognized on the basis of attributes which belong to a selected sub-quantity.

### BRIEF DESCRIPTION OF THE DRAWINGS

The invention will be explained in detail below by means of an exemplary embodiment with reference to the Figures of the drawings.

FIG. 1 schematically shows an object monitored by means of a plurality of sensor nodes of a sensor network, which object is a fence, wherein one of the sensor nodes is attached to each lattice bar.

FIG. 2 shows a histogram in which acceleration measurement values determined by a sensor node are represented.

FIG. 3 shows a schematic representation of an attribute selection according to the invention.

FIG. 4 shows a schematic representation of a cross-validation.

FIG. 5 shows an exchange of information between a base station and a sensor node after completion of the configuration phase.

### DETAILED DESCRIPTION

The attribute selection according to the invention will be illustrated below with reference to a system for monitoring a fence. It is the object of the system to recognize and indicate safety-relevant events such as the climbing over the fence by a person. It can be provided to recognize and differentiate various types of events such as e.g. the events “leaning against the fence”, “shaking the fence”, “climbing up the fence to look over the fence” and “climbing over the fence” on different fence portions.

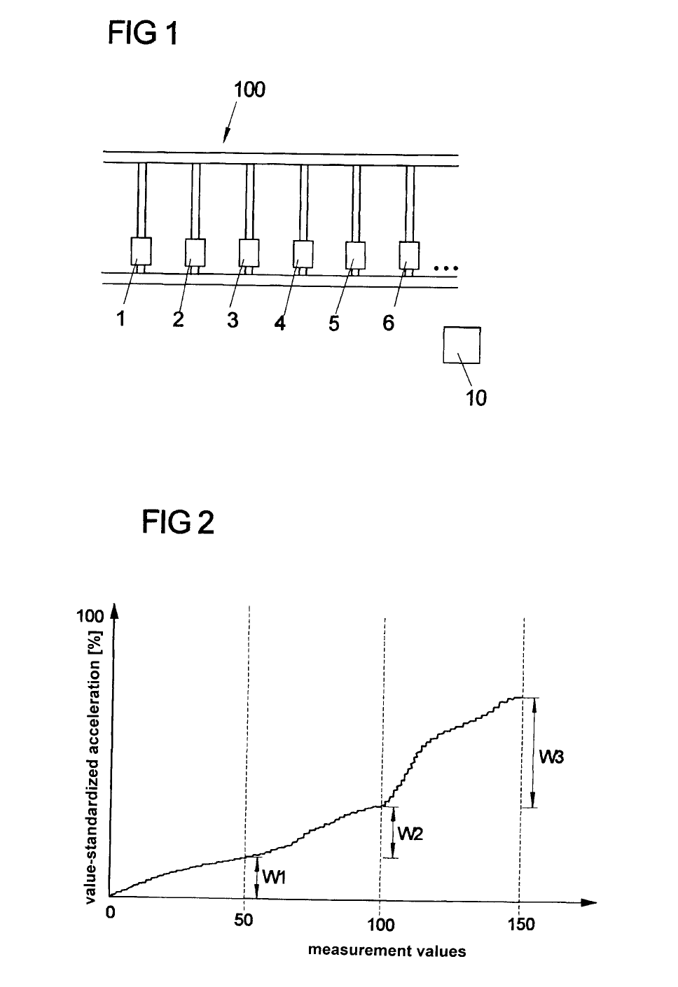

According to FIG. 1, a fence 100 is provided, which comprises a plurality of lattice bars. On each of the lattice bars a sensor node 1, 2, 3, 4, 5, 6, . . . is arranged. The individual sensor nodes 1-6 each include an acceleration sensor, a processor, a data memory, a radio module and an energy supply for example in the form of a battery. Such sensors are known per se and described for example in Dziengel, N.: “Verteilte Ereigniserkennung in Sensornetzen”, thesis, Free University of Berlin, October 2007, section 3.1. The sensor nodes 1-6 exchange data among each other and with a base station by radio. The sensor nodes 1-6 and the base station 10 form a sensor network.

The acceleration sensors of the network nodes 1-6 measure the movements of the fence 100, which occur at different events such as climbing or shaking, and communicate the recognized events to the base station 10 by radio.

The position of the sensor nodes 1-6 of a fence portion among each other is encoded in the network addresses of the sensor nodes. If elements of the quantity of the natural numbers are chosen for the network addresses and if the sensor nodes are numbered continuously, as in the present case, according to their position on the fence 100, the neighborhood information of a sensor node is obtained from the predecessor and successor function, respectively. For example, the node with the address 4 on the left through the node 3 and on the right through the node 5 is adjacent. This type of encoding the position of the sensor nodes 1-6 among each other is possible because it corresponds to the physical properties of the event to be measured. The movement which occurs at a certain point of the fence 100 due to an event propagates due to the mechanical coupling of the fence elements and can also be measured in attenuated form at the adjacent fence elements. Thus, a direct semantic relation exists between the physical proximity in the object to be observed and the topological information on the addresses deposited in the sensor network.

In principle, however, encoding the topological information can also be effected in some other way. For example, the system can be expanded by a configuration component which allows the user to explicitly define the position of the nodes among each other, for example by defining the space coordinates for each sensor node.

It is important here that encoding is effected with respect to the propagation characteristic of the event to be recognized. For mechanically transmitted movements, such as on a fence, the neighborhood relation of the sensor nodes is useful for example; for the uniformly spreading temperature gradient in the vicinity of a fire for example the space coordinates of the sensor nodes can be used.

The sensor network is configured for carrying out a configuration phase and for carrying out an execution phase. In the configuration phase the attribute selection is made. The attributes extracted on the individual sensor nodes 1-6 as described below are evaluated by the base station 10 as central system component. The central system component 10 performs an attribute selection and forms reference attribute vectors which each characterize defined events. After completion of the configuration phase, these reference attribute vectors together with further information from the base station 10 are transmitted to the individual sensor nodes 1-6 for the execution phase. In the execution phase, a distributed pattern recognition then is effected on the sensor nodes 1-6 alone, without involving the central system component 10.

When training the sensor network on the fence 100 during the configuration phase an attribute selection must be made, which optimizes the future recognition accuracy, namely both with respect to the correct classification of the events and with respect to an error tolerance with regard to an unreliable data exchange between the nodes and with respect to the energy efficiency. During the attribute selection, the attributes best suited for the future pattern and event recognition therefore are selected from a quantity of available attributes.

Possible attributes which form the total quantity of the attributes determined from the raw data on the sensor nodes 1-6, from which a sub-quantity then is selected according to the invention, are histogram values, minimum values and maximum values for example of the acceleration, mean values, slope values in defined time intervals and/or intensity changes in defined time intervals. Further possible attributes are described in WO 2007/135662 A1.

An example for an attribute determination will be explained below with reference to FIG. 2. The attribute determination of FIG. 2 is effected with reference to histogram values. It is assumed that each of the sensor nodes 1-6 comprises an acceleration sensor. Upon occurrence of an event during the configuration phase each sensor node 1-6 extracts three attributes per space axis from the respectively measured acceleration data.

Each sensor node 1-6 continuously determines the current acceleration values for all three directions in space and for this purpose continuously outputs acceleration measurement values during the movement, which subsequently also are referred to as samples, as they each represent a sample value of the current acceleration. For example, during a time unit of 1 second a certain number of measurement values or samples is provided. The individual acceleration measurement values of a direction in space (x, y, z) are represented in a histogram as shown in FIG. 2. The histogram includes k histogram classes, wherein k is a natural number ≧1 and equal to the number of attributes per axis, which are derived from the measurement values.

The measurement values initially are standardized to a uniform time and value measure, in order to make the acceleration measurements of different events comparable. For example, a linear standardization is used, which uniformly depicts the events for an event duration of 4 seconds and standardizes the intensity for a maximum excursion determined during the training.

Each of the correspondingly standardized samples now is sorted into one of the histogram classes. The number of samples per class is limited to 1/k of the measurement values detected. The smallest measurement values, i.e. the measurement values with the smallest acceleration values, are sorted into the first class, until this class is filled. In the exemplary embodiment of FIG. 2, the first 50 samples fall in the first class. In the following, the remaining k−1 classes are filled up, i.e. in the exemplary embodiment of FIG. 2 the second histogram class with the samples 50 to 100 and the third histogram class with the samples 100 to 150. Thus, each sample is assigned to one of the k classes.

In a next step, the range of variation of the data collected is considered for each histogram class and for this purpose for example the difference between the maximum value and the minimum value is determined in the corresponding class. The differences thus produced form suitable attributes for the vector formation. They can be compared with the differences of other patterns, when they originate from the same histogram class. An advantage of this type of attribute determination consists in that the histogram classes always contain the same number of samples, so that in particular there is no risk that a histogram class contains no elements. The class size also is variable.

In class 1 of FIG. 2, the range of variation is indicated as W1, in class 2 as W2 and in class 3 as W3. Hence, three attributes W1, W2, W3 are found, which characterize the movement made. Thus, three attributes W1, W2, W3 are available for the direction in space considered, which form a three-element attribute vector.

For the three directions in space considered, a nine-element attribute vector hence is available per sensor node 1-6.

An attribute type characterizes attributes of the individual sensor nodes 1-6 corresponding to each other. The term designates types of attributes which occur on each or at least on a plurality of the sensor nodes, whereas the term “attribute” designates the representative of the attribute type on a certain sensor node. In the case of FIG. 2, for example, an attribute type is defined by the derivation of a feature from an nth histogram class, i.e. in the case of FIG. 2 the attribute W1 belongs to the attribute type “first histogram class”, the attribute W2 belongs to the attribute type “second histogram class”, etc.

It is again pointed out that instead of histogram values other typical attributes/attribute types of a movement, such as the duration of a movement, minimum acceleration values, maximum acceleration values or average acceleration values, can also be used for forming the attributes. When evaluating histogram values, the same can also be evaluated other than described with reference to FIG. 2 for forming attributes. For example, it can alternatively be provided that certain acceleration ranges correspond to the individual histogram classes and the number of the samples falling within an acceleration range represents the evaluated attribute. Moreover, the number of attributes per space axis as indicated in FIG. 2 should of course only be understood as an example.

If all nine attributes of each sensor node 1-6 according to the exemplary embodiment of FIG. 2 would now be considered in the distributed pattern recognition or classification to be performed, on the whole a too large number of attributes would be present, which would lead to the disadvantages mentioned already. Therefore, an attribute selection is made.

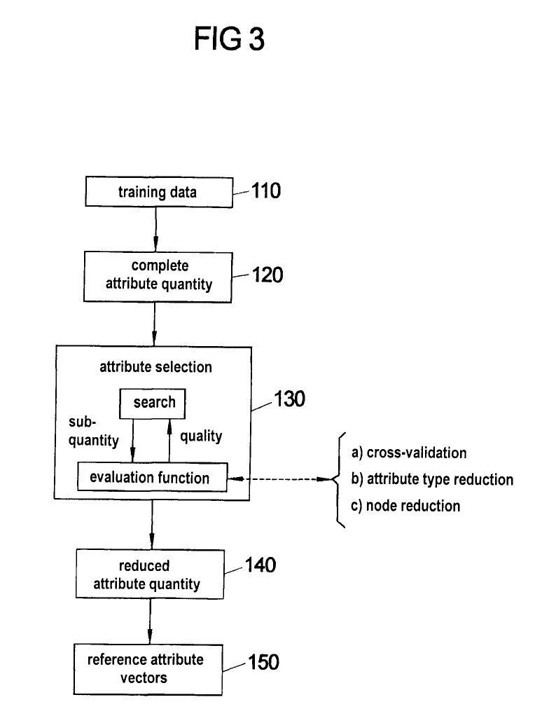

The attribute selection is schematically represented in FIG. 3. In step 110, the raw data initially are detected for a certain event on all sensor nodes 1-6. Since the configuration phase exists, the raw data also are referred to as training data. Subsequently, all sensor nodes 1-6 determine attributes determined from the training data according to defined rules, as described by way of example with reference to FIG. 2. The attributes determined by each sensor node 1-6 are transmitted to the base station 10, so that the complete attribute quantity 120 is available to the same.

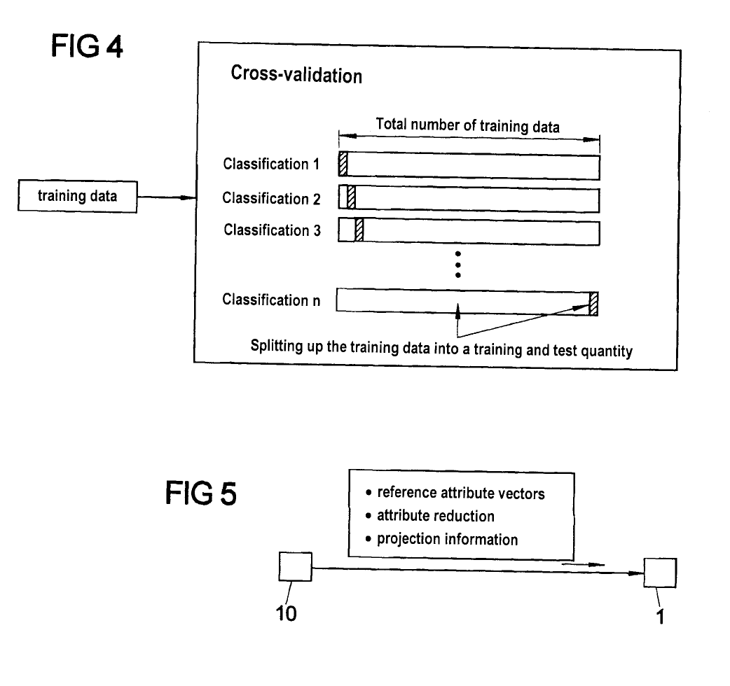

Now the attribution selection 130 is made. There is made a sliding, iterative search by using a cross-validation schematically represented in FIG. 4 as evaluation function. Such cross-validation is known for example from Gutierrez-Osuna, Ricardo: “Lecture on “Intelligent Sensor Systems””, Write State University, so that its execution is not described here in detail. In general, the idea underlying the cross-validation consists in that the existing data are split up into a training and a test quantity. A classifier is established with reference to the training quantity. The error rate is calculated with reference to the independent test quantity, which was not used for the training. In the cross-validation, sub-quantities repeatedly are selected from the total quantity of the available attributes and the corresponding quantities are compared with each other. The attribute selection is made with reference to the average error of all classifications and sub-quantities, respectively. In principle, another weighting function can also be chosen instead of a cross-validation.

The quality determined now is additionally weighted with reference to information on the topological origin of the attributes of the sensor network, in order to achieve a reduced attribute quantity adjusted to the case of application. The contribution of an attribute to the recognition rate is weighted with two additional criteria.

On the one hand, this is the criterion of how often the attribute in question (i.e. an attribute of the same attribute type, such as “first histogram class” or “duration of the event”) has already been used by another node. It applies that a more frequent use stands for a greater weight of the attribute. With this criterion it is achieved that rather no rarely considered attribute types are used in the optimization and the same can be omitted during the calculation and transmission.

On the other hand, there is used the criterion of how many other attributes (i.e. attributes of other attribute types) a node has contributed already. Attributes of frequently used nodes have a higher weight. With this criterion it is achieved that rather few nodes are used in the recognition, and therefore the susceptibility of the event recognition with respect to transmission errors is improved and the required energy consumption for transmission repetitions is reduced. It should be taken into account that a radio transmission is potentially susceptible to errors and in principle it is desirable to work with as little individual data as possible and thus minimize the number of the total nodes which contribute information to the distributed event recognition.

In both cases, topological information on the place of origin of the attributes within the network is evaluated. In the first case, the question as to whether an attribute in question has already been used by another node implies the assignability of an attribute to a node and therefore the information on the place of origin of the attribute within the network. In the second case, the question as to how many attributes a node already has contributed likewise implies the assignability of the attributes to one node each. The topological information thus is included in both criteria.

The weighting of the quality of a concrete attribute selection from the cross-validation requires exactly this information. While in a commonly used attribute selection the attributes exclusively are observed with reference to their type (e.g. “duration”), the method and sensor network according to the invention is based on type and place of origin (e.g. the duration of a training event on a certain sensor node).

The result of the cross-validation initially is the recognition accuracy for a given attribute selection. This metric is weighted in consideration of the concretely selected attributes with coefficients which result from the two additional criteria and can be determined for example in dependence on the technical implementation of the sensor nodes and the spreading place.

In the exemplary embodiment considered here, this concretely means that the used algorithm tries to rather use attributes which are relevant for the classification independent of the node position relative to the location of the event. If an event for example takes place at node 5 and both at node 5 and at the adjacent node 4 the attribute of the maximum amplitude turns out to be relevant for the classification, this attribute will be selected rather than the attribute of the duration of the event, which has been regarded as relevant merely on node 5. Since the attribute type of the duration of the event hence can completely be omitted, the data volume in the sensor network as a whole is reduced.

In the selection it is additionally taken into consideration how may attributes a node in a certain position relative to the location of the event already has contributed to the recognition. Attributes of nodes which already have contributed attributes will be selected rather than attributes of nodes from which no attributes have been selected yet according to the selection progress made so far. Thus, in concrete terms, the attribute of the maximum amplitude will be selected by the adjacent node 4 rather than the possibly more relevant attribute of the maximum amplitude by the adjacent node 6, if other attributes have already been selected by node 4. The less nodes are necessary to unambiguously describe an event, the more the susceptibility of the distributed event recognition to package losses will be reduced.

In particular, the attribute selection can lead to the fact that only certain attribute types are used for the classification. As explained already, an attribute type characterizes attributes of the individual sensor nodes corresponding to each other.

The weighting of the two additional criteria for example depends on the energy costs of the data evaluation and transmission of the sensor nodes and on the scenario-dependent error probability of the data transmission. For example, if the data evaluation and transmission is very expensive (e.g. because the computing capacity of the sensor nodes is very limited or the sensor nodes are spread far away from each other), only attributes of a single attribute type might be used in the extreme case. For example, if the error probability (due to the radio interferences of the machines used in construction) is very high, only one sensor node might participate in the event recognition in the extreme case (whereby no more radio transmission would be necessary).

In summary, the attribute reduction is effected on the basis of three measures, namely a) a weighting like e.g. a cross-validation known per se, b) the use of topological information for attribute reduction by attribute type reduction, and c) the use of topological information for attribute reduction by node reduction, as schematically represented in step 130. It is pointed out that the measures b) and c) both need not be realized, but it also lies within the scope of the present invention when only one of these measures is realized.

After completion of the attribute reduction a reduced attribute quantity 140 is available. By averaging the training values of the selected attributes of the reduced attribute quantity, the prototypes of the classes, i.e. of the events to be recognized, then are formed. For example, reference attribute vectors 150 are formed, which represent multi-element vectors of a multi-dimensional vector space, which contain the remaining attributes of all sensor nodes as vector elements. In the configuration phase, such reference attribute vectors are formed for a plurality of possible events, for example for the events that at the first, second, third, etc. fence post of FIG. 1 a person tries to climb over the fence, steps against the same, shakes the same, etc.

For the execution phase according to FIG. 5, in one configuration variant, the following information additionally is transmitted after completion of the training from the base station 10 to all sensor nodes 1-6 in addition to the determined reference attribute vectors for the individual events.

On the one hand, information on the attribute reduction is transmitted to the nodes. Thus, the quantity of the attributes which are used independent of the relative position of the nodes in the reference attribute vectors is transmitted to the sensor nodes 1-6. All other attributes are irrelevant for the event recognition and will neither be calculated nor be sent in the future. In the implementation, this can be realized for example by a bit mask.

The reference attribute vector of each class is composed of attributes of different types from different nodes. Attributes which are used independent of the relative position of the nodes in the reference attribute vectors are those whose type occurs in the reference attribute vector, no matter which node they originate from. In the application phase one does not know a priori at which point an event will occur. Therefore, all nodes must supply all attribute types independent of their position.

On the other hand, projection information is transmitted to the nodes. Thus, for each sensor node represented in the reference vector information on a projection dependent on the relative position of the node is transmitted from the attribute vector space into the reference attribute vector space. This accounts for the fact that the structure of the reference attribute vector given by the attribute selection must be taken into consideration before each classification. In the implementation, this can be realized by a two-dimensional array whose indices encode position and attribute and whose elements represent the dimension in the reference attribute vector space.

In the application example, the relative position is obtained from the addresses of the nodes. If for example in the training phase during an event at node 5 the left neighbor node 4 has provided a very useful attribute, it is necessary in the application phase that all nodes always pay attention to that very attribute from their left neighbor. As explained above, it is not known at which point the event will occur. The projection ensures that the attribute relevant in this example each is projected from the left neighbor (independent of its actual address) onto the same axis of the reference attribute vector space.

In a current event recognition during the execution phase, only the attributes marked as relevant are extracted from the raw data at the used sensor nodes and transmitted to the other sensor nodes in the attribute vector of the respective sensor node. The attribute vectors received then are combined to a current attribute vector in consideration of the position-dependent projection and only then compared with the reference attribute vector, for example by forming the Euclidean distance. The comparison leads to a classification of the event and hence to an event recognition.

The event recognition during the execution phase can be effected on the sensor nodes 1-6 alone, without involving the base station 10. This is only required for performing the relatively complex calculations for attribute reduction during the configuration phase.

The method of the invention is an example for a distributed event recognition, in which a plurality of sensor nodes are included in the decision-making process, in order to attain a higher recognition accuracy. Events which occur in the sensor network are interpreted as pattern.

The method of the invention reduces the data necessary for the distributed event recognition already in the recognition process, in that during the formation of attributes from the raw data on the individual sensor nodes 1-6 certain attributes are left out a priori and are not formed. Hence, the energy consumption of the sensor network is reduced by saving radio transmissions and computing operations. In one aspect, the solution according to the invention additionally or alternatively reduces the number of nodes involved in the event recognition and thus increases the reliability of the method, since less data transmission problems can occur. As a side effect, the solution according to the invention furthermore increases the accuracy of the event recognition, as it limits the dimensionality of the reference attribute vector space and thus provides for comparisons between reference and attribute vectors in a more conclusive way.

The solution according to the invention is not limited to the exemplary embodiments described above, which should merely be understood by way of example. In particular, the recognition of safety-relevant events on a fence, in which sensor nodes substantially are arranged along a space axis, only represents an application example. The method likewise can be used in more complex two- and three-dimensional systems. An exemplary embodiment of a two-dimensional case is a system for monitoring areas, such as forest areas. In this context, a typical safety-relevant event would be the outbreak of a fire, which could be identified by recognizing the increase in temperature at certain points. An exemplary embodiment of a three-dimensional case relates to a system for monitoring large-scale industrial plants. The method for example serves to recognize the event of locally escaping gases via the change in the gas concentration at the measurement points in a room. Such recognition can be used to identify gas leaks or the like in plants.

1.-24. (canceled)

25. A method for attribute selection for an event recognition in sensor networks, with the following steps:
in a configuration phase,
providing a quantity of attributes by sensor nodes of a sensor network, which characterize an event to be recognized, together with information on the topological origin of the attributes within the sensor network, and
selecting a sub-quantity from the quantity of attributes, wherein the selection is made in consideration of the information on the topological origin of the attributes,
in an execution phase,
performing an event recognition for an event to be currently recognized on the basis of attributes which belong to a selected sub-quantity.

26. The method according to claim 25, wherein selecting a sub-quantity comprises making a weighting to the effect that such attributes of the total quantity of the attributes determined are weighted more in which corresponding attributes also are determined by other network nodes.

27. The method according to claim 25, wherein selecting a sub-quantity comprises a weighting to the effect that such attributes of the total quantity of the attributes determined are weighted more which originate from a node which already has contributed other attributes for selection.

28. The method according to claim 25, wherein selecting a sub-quantity comprises carrying out an iterative selection process on the total quantity of the attributes determined.

29. The method according to claim 25, wherein selecting a sub-quantity comprises carrying out a cross-validation on the total quantity of the attributes determined.

30. The method according to claim 25, wherein providing a quantity of attributes which characterize an event to be recognized comprises the following steps within the configuration phase:
providing a plurality of sensor nodes of the sensor network,
executing an event to be recognized,
on each of the sensor nodes detecting measurement values which are triggered by the event to be recognized,
on each of the sensor nodes determining a plurality of attributes which characterize the event from the measurement values,
forming the quantity of attributes which characterize an event to be recognized from the sum of attributes determined on the sensor nodes.

31. The method according to claim 25, wherein in the configuration phase a multi-dimensional reference attribute vector is formed from the attributes of the selected attribute sub-quantity, with which a multi-dimensional current attribute vector determined in the execution phase is compared for event recognition.

32. The method according to claim 31, wherein in the configuration phase a plurality of multi-dimensional reference attribute vectors are formed for a plurality of events to be recognized.

33. The method according to claim 31, wherein the execution phase comprises the attributes:
providing the reference attribute vectors determined in the configuration phase,
providing information on an attribute selection made in the configuration phase,
for an event to be currently recognized determining merely attributes on all or some of the sensor nodes which belong to the attribute selection made,
representing these attributes as multi-dimensional current attribute vector, and
making a classification by comparing the current attribute vector with the reference attribute vectors.

34. The method according to claim 25, wherein the selection is made by a central system component which communicates with the individual sensor nodes in a wireless manner.

35. The method according to claim 25, wherein after completion of the configuration phase information on the quantity of the attributes is transmitted into the sensor nodes, which is used in the reference attribute vectors independent of the relative position of the network nodes, and the remaining attributes in the network nodes are neither calculated nor sent.

36. The method according to claim 25, wherein after completion of the configuration phase information furthermore is transmitted into the sensor nodes, which for each sensor node represented in the reference vector relates to a projection from the attribute vector space into the reference attribute vector space dependent on the relative position of the sensor node.

37. The method according to claim 25, wherein acceleration measurement values are detected as measurement values corresponding with an event.

38. The method according to claim 25, wherein as attributes which characterize an event histogram values and/or minimum values and/or maximum values and/or mean values and/or slope values for defined time intervals and/or intensity changes for defined time intervals are determined.

39. The method according to claim 25, wherein the information on the topological origin of the attributes is encoded in the network addresses of the sensor nodes.

40. The method according to claim 25, wherein the information on the topological origin of the attributes is provided by defining space coordinates for each sensor node.

41. A sensor network with a plurality of sensor nodes, wherein the sensor network can be configured for carrying out a configuration phase and for carrying out an execution phase,
wherein in the configuration phase the sensor network is configured to
provide a quantity of attributes by the sensor nodes of the sensor network, which characterize an event to be recognized, together with information on the topological origin of the attributes within the sensor network, and
select a sub-quantity from the quantity of attributes, wherein the selection is made in consideration of the information on the topological origin of the attributes,
and wherein in the execution phase the sensor network is configured to
perform an event recognition for an event to be currently recognized on the basis of attributes which belong to a selected sub-quantity.

42. The sensor network according to claim 41, comprising a central system component which selects the sub-quantity from the total quantity of the attributes determined.

43. The sensor network according to claim 41, wherein the sensor network is configured to select a sub-quantity by making a weighting to the effect that such attributes of the total quantity of the attributes determined are weighted more which are also determined by other network nodes.

44. The sensor network according to claim 41, wherein the sensor network is configured to select a sub-quantity by making a weighting to the effect that such attributes of the total quantity of the attributes determined are weighted more which originate from a node which already has contributed other attributes for selection.

45. The sensor network according to claim 41, further comprising a module which for selecting a sub-quantity performs an iterative selection process on the total quantity of the attributes determined.

46. The sensor network according to claim 45, wherein the module comprises a module for carrying out a cross-validation on the total quantity of the attributes determined.

47. The sensor network according to claim 41, wherein the sensor network is configured to encode information on the topological origin of the attributes into the network addresses of the sensor nodes.

48. A computer program with program code for carrying out the method according to claim 25, when the computer program is executed on a computer.
